(19) United States
(12) Patent Application Publication
(10) Pub. No.: US 2026/0068947 A1
(43) Pub. Date: Mar. 12, 2026

(54) ATOMIZER AND ATOMIZATION DEVICE

(71) Applicant: SHENZHEN GEEKVAPE TECHNOLOGY CO., LTD., Shenzhen (CN)

(72) Inventors: Yansheng ZHANG, Shenzhen (CN); Dongli WANG, Shenzhen (CN)

(73) Assignee: SHENZHEN GEEKVAPE TECHNOLOGY CO., LTD., Shenzhen (CN)

(21) Appl. No.: 19/315,019

(22) Filed: Aug. 29, 2025

(30) Foreign Application Priority Data
Sep. 11, 2024 (CN) 202422224872.8
Dec. 12, 2024 (CN) 202423073552.3

(51) Int. Cl. A24F 40/485; A24F 40/10; A24F 40/46; H05B 3/42

(52) U.S. Cl. CPC A24F 40/485; A24F 40/10; A24F 40/46; H05B 3/42

(57) ABSTRACT

The atomizer includes: a housing having a nozzle, and an exhaust duct in communication with the nozzle is provided within the housing; a first sealing member disposed within the housing and divided the housing into a liquid storage chamber and an air inlet chamber, the first sealing member is provided with a first mounting hole, and an end of the first sealing member facing the nozzle is provided with a liquid retaining structure; an atomizer core disposed within the liquid storage chamber, an end of the atomizer core being in communication with the exhaust duct, and another end of the atomizer core extending into the first mounting hole and being sealingly connected with the first mounting hole; a side wall of the atomizer core is provided with liquid inlets, and one liquid inlet is disposed corresponding to the liquid retaining structure and is partially blocked by the liquid retaining structure.

### CROSS REFERENCE TO RELATED APPLICATION

This application claims priority to Chinese Application No. 202423073552.3, filed on Dec. 12, 2024, which claims priority to Chinese Application No. 202422224872.8, filed on Sep. 11, 2024, the contents of which are incorporated into the present application by reference.

### TECHNICAL FIELD

The present application relates to the technical field of atomization devices, and more particularly to an atomizer and an atomization device.

### BACKGROUND

Currently, the atomizer core of electronic atomization devices is often located within a liquid storage chamber. A matrix liquid flows in through a liquid inlet located on the side of the atomizer core. The matrix liquid is atomized and aerosols are generated through the heating of the atomizer core. However, the design of the liquid inlet of the atomizer core in existing atomizers has several drawbacks. Specifically, the flow rate and pressure at the liquid inlet are difficult to be controlled. Excessive liquid flow rate and/or pressure at the liquid inlet can easily cause some matrix liquid to leak from the atomizer core into the exhaust port without being atomized, resulting in leakage at the nozzle and affecting the user experience.

### SUMMARY

In order to address the problem of liquid leakage at the liquid inlet of the atomizer core in the prior art, the present application provides an atomizer and an atomization device.

According to an embodiment of the technical solution of a first aspect of the present application, an atomizer is provided, which includes: a housing provided with a nozzle at one end of the housing in a first direction, and an exhaust duct in communication with the nozzle is provided within the housing; a first sealing member disposed within the housing and divided an interior space of the housing into a liquid storage chamber and an air inlet chamber, the first sealing member is provided with a first mounting hole, and an end of the first sealing member facing the nozzle is provided with a liquid retaining structure; an atomizer core disposed within the liquid storage chamber, an end of the atomizer core being in communication with the exhaust duct, and another end of the atomizer core extending into the first mounting hole and being sealingly connected with the first mounting hole; in which a side wall of the atomizer core is provided with at least one liquid inlet, and at least one of liquid inlets is disposed corresponding to the liquid retaining structure in a lateral direction of the atomizer core, and is partially blocked by the liquid retaining structure.

In a further embodiment of the present application, a first spacing is presented between the liquid retaining structure and an outer wall of the atomizer core, such that a liquid inlet channel is formed between the liquid retaining structure and the corresponding liquid inlet.

In a further embodiment of the present application, a size of the liquid inlet is larger than a size of the liquid retaining structure in the first direction, and the liquid inlet includes a blocked area and an exposed area, the exposed area is located at an end of the blocked area adjacent to the nozzle; and/or
a size of the liquid inlet is smaller than a size of the liquid retaining structure in a circumferential direction of the atomizer.

In a further embodiment of the present application, an area of the blocked area accounts for ⅔ to ¾ of a total area of the liquid inlet.

In a further embodiment of the present application, on a plane perpendicular to the first direction, a projection of an inner tube section is located an inner side of the projection of an atomization chamber.

In a further embodiment of the present application, the atomizer core is a cylindrical structure; a side of the liquid retaining structure facing the atomizer core is provided with a curved surface structure, and the curved surface structure is arranged coaxially with the atomizer core.

In a further embodiment of the present application, an end of the liquid inlet adjacent to the nozzle is provided with a first curved edge; and an end of the liquid retaining structure adjacent to the nozzle is provided with a second curved edge, a center of the first curved edge and a center of the second curved edge are located on a same side, and a radius of the second curved edge is greater than or equal to a radius of the first curved edge.

In a further embodiment of the present application, the first sealing member is further provided with a raised liquid guide plate, and the liquid guide plate is configured to direct an atomized liquid toward the liquid inlet of the atomizer core. Based on this, the atomized liquid is guided to the liquid inlet of the atomizer core by the liquid guide plate, which is conductive to guide the atomized liquid to the atomizer core when it is in a low liquid level, so as to improve the utilization of the atomized liquid and prevent the atomizer core from burning out.

In a further embodiment of the present application, the first sealing member is provided with a plurality of liquid guide plates, and the plurality of liquid guide plates are arranged radially outwardly around a periphery of the atomizer core. This is conductive to increase the coverage of the liquid guide plates, and makes it easier for the user to select a liquid guide plate to direct the atomized liquid to the atomizer core during the guidance operation.

In a further embodiment of the present application, the first sealing member is provided with two long sides opposite to each other and two short sides opposite to each other; an extension line from the liquid guide plate toward a center of the first sealing member intersects a middle line between the two long sides of the first sealing member to form an inclination angle of the liquid guide plate, and the inclination angle of the liquid guide plate is ranged from 45° to 90°. This ensures the flow rate of the liquid while reducing the amount of liquid retained in front of the liquid guide plate, thereby improving the flow diversion effect.

In a further embodiment of the present application, a drainage gap is formed between an extension end of the liquid guide plate and the inner wall of the liquid storage chamber. This is conductive to reduce the amount of liquid retained in front of the liquid guide plate by the liquid guide plate, so as to allow any overflowing atomized liquid to flow through the drainage gap and be redirected to the atomizer core.

In a further embodiment of the present application, a height of the liquid guide plate rising from the first sealing member is one-third of a diameter of the liquid inlet, so as to prevent obstruction of the atomized liquid flowing to the liquid inlet.

In a further embodiment of the present application, the liquid guide plates are symmetrically connected to two sides of the liquid retaining structure, and the liquid retaining structure with two sides being connected with the liquid guide plates are provided with drainage holes. The atomized liquid remaining between the liquid retaining structure and the liquid guide plates on both sides can be discharged from the drainage holes on the liquid retaining structure and directly flow to the atomizer core or be redirected to the atomizer core, and the problem of liquid easily accumulating between the liquid retaining structure and the liquid guide plates on both sides is effectively solved.

In a further embodiment of the present application, the liquid guide plate is integrally connected to the liquid retaining structure and the first sealing member, so as to improve sealing and flow diversion efficiency.

In a further embodiment of the present application, the atomizer core includes: an atomizer core sleeve, an end of the atomizer core sleeve is connected to the exhaust duct and another end of the atomizer core sleeve is sealingly connected to the first mounting hole, the liquid inlet is deposed on a side wall of the atomizer core sleeve; an atomizer core body, disposed within the atomizer core sleeve and is provided with an air passage channel penetrating through the atomizer core body in the first direction; and a liquid obsorption structure, disposed within the atomizer core sleeve and covers an outer surface of the atomizer core body.

In a further embodiment of the present application, the atomizer further includes a support seat disposed within the air inlet chamber, an air guiding chamber is formed within the support seat, and the support seat is provided with a first communication port and a second communication port that are in communication with the air guiding chamber; the housing comprises an air inlet duct communicating the air inlet chamber with an external atmosphere; and the first communication port is in communication with an end of the atomizer core away from the nozzle, and the second communication port is in communication with the air inlet chamber or the air inlet duct.

In a further embodiment of the present application, an end of the housing away from the nozzle is provided with a second mounting hole penetrating through the housing in the first direction; an end of the support seat away from the nozzle is an assembly end, the assembly end is disposed in the second mounting hole and is provided with an electrode mounting groove and a process assembly groove, the support seat is provided with a through hole configured for communicating the air guiding chamber with the electrode mounting groove, and a conductive portion of the atomizer core extends through the through hole and into the electrode mounting groove; an electrode is mounted in the electrode mounting groove, the electrode is electrically connected to the conductive portion of the atomizer core and capable of being electrically connected to a power supply; and the process assembly groove is configured to connect and assemble with an external processing device, so that the conductive portion of the atomizer core is able to be bent by the external processing device during processing.

The embodiments of the technical solution of a second aspect of the present application further provide an atomization device, which includes: a power supply; and the atomizer according to any embodiment of the first aspect. The atomizer core is electrically connected to the power supply.

Beneficial effects of the above-mentioned technical solution of the present application:

The atomizer of the present application provides a liquid retaining structure on the first sealing member connected to the atomizer core, so that the liquid inlet of the atomizer core is partially blocked laterally by the liquid retaining structure. This reduces the liquid flow rate and pressure in front of the atomizer core in the liquid inlet, so as to reduce the possibility of matrix liquid at the liquid inlet leaking through the atomizer core without being atomized. This improves the problem of matrix liquid leaking through the nozzle, the user experience is improved, and the waste of the matrix liquid is reduced.

### BRIEF DESCRIPTION OF THE DRAWINGS

In order to explain the embodiments of the present application more clearly, a brief introduction regarding the accompanying drawings that need to be used for describing the embodiments of the present application or the prior art is given below; it is obvious that the accompanying drawings described as follows are only some embodiments of the present application, for those skilled in the art, other drawings can also be obtained according to the current drawings on the premise of paying no creative labor.

FIG. 1 is a schematic perspective view of an atomizer in one embodiment of the present application;

FIG. 2 is a schematic side view of an atomizer in one embodiment of the present application;

FIG. 3 is a cross-sectional view taken along the A-A line in FIG. 2;

FIG. 4 is a schematic view of parts of an atomizer in one embodiment of the present application;

FIG. 5 is a front view of FIG. 4;

FIG. 6 is a top view of FIG. 4;

FIG. 7 is a first top view of a first sealing member in one embodiment of the present application;

FIG. 8 is a first perspective view of an atomizer core mounted on a first sealing member in one embodiment of the present application;

FIG. 9 is a second top view of a first sealing member in one embodiment of the present application;

FIG. 10 is a top view of an atomizer core mounted on a first sealing member in one embodiment of the present application;

FIG. 11 a second perspective view of an atomizer core mounted on a first sealing member in one embodiment of the present application;

FIG. 12 is a first schematic perspective view of a first sealing member in one embodiment of the present application;

FIG. 13 is a second schematic perspective view of a first sealing member in one embodiment of the present application;

FIG. 14 is a schematic perspective view of a support seat in one embodiment of the present application;

FIG. 15 is a schematic view of a bottom of a support seat in one embodiment of the present application;

FIG. 16 is a schematic perspective view of an atomizer core in one embodiment of the present application from another perspective; and

FIG. 17 is a schematic block diagram of an atomization device in one embodiment of the present application.

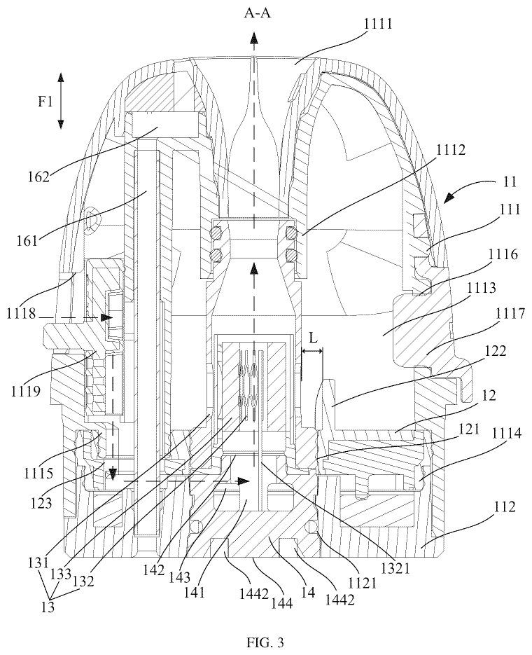

The solid arrow F1 in the above figures indicates the first direction, and the dashed arrow in FIG. 3 indicates the airflow direction.

Reference numerals in the figures are listed as following:
100 atomizer, 11 housing, 111 shell, 1111 nozzle, 1112 exhaust duct, 1113 liquid storage chamber, 1114 air inlet chamber, 1115 air inlet duct, 1116 liquid filling port, 1117 liquid filling plug, 1118 air inlet, 1119 air inlet valve, 112 base, 1121 second mounting hole, 12 first sealing member, 120 drainage gap, 121 first mounting hole, 122 liquid retaining structure, 1221 curved surface structure, 1222 second curved edge, 1223 drainage hole, 123 air inlet opening, 13 atomizer core, 131 atomizer core sleeve, 1311 liquid inlet, 1312 blocked area, 1313 exposed area, 1314 first curved edge, 132 atomizer core body, 1321 conductive portion, 133 liquid obsorption structure, 14 support seat, 141 air guiding chamber, 142 first communication port, 143 second communication port, 144 assembly end, 1441 electrode mounting groove, 1442 process assembly groove, 145 through hole, 15 electrode, 161 sensing airway, 162 airflow sensor, and 17 liquid guide plate.

200 atomization device, 21 power supply.

### DETAILED DESCRIPTION OF THE EMBODIMENTS

In order to make the purpose, the technical solution and the advantages of the present application be clearer and more understandable, the present application will be further described in detail below with reference to accompanying figures and embodiments. It should be understood that the specific embodiments described herein are merely intended to illustrate but not to limit the present application.

It is noted that when a component is referred to as being “fixed to” or “disposed on” another component, it can be directly or indirectly on another component. When a component is referred to as being “connected to” another component, it can be directly or indirectly connected to another component.

In the description of the present application, it needs to be understood that, directions or location relationships indicated by terms such as “length”, “width”, “up”, “down”, “front”, “rear”, “left”, “right”, “vertical”, “horizontal”, “top”, “bottom”, “inside”, “outside”, and so on are the directions or location relationships shown in the accompanying figures, which are only intended to describe the present application conveniently and simplify the description, but not to indicate or imply that an indicated device or component must have specific locations or be constructed and manipulated according to specific locations; therefore, these terms shouldn't be considered as any limitation to the present application.

In addition, terms “the first” and “the second” are only used in describe purposes, and should not be considered as indicating or implying any relative importance, or implicitly indicating the number of indicated technical features. As such, technical feature(s) restricted by “the first” or “the second” can explicitly or implicitly includes one or more such technical feature(s). In the description of the present application, “a plurality of” means two or more, unless there is additional explicit and specific limitation.

The atomizer provided in the present application is used to atomize a heated matrix liquid to generate an aerosol for inhalation by a user. The atomizer includes a housing, a first sealing member, and an atomizer core. The first sealing member and the atomizer core are both disposed within the housing. The first sealing member divides the interior space of the housing into a liquid storage chamber and an air inlet chamber. The liquid storage chamber is used to store matrix liquid, and the atomizer core is disposed within the liquid storage chamber and is used to heat and atomize the matrix liquid flowing from the liquid storage chamber into the atomizer core. One end of the atomizer core is in communication with a nozzle on the housing for inhalation, and another end of the atomizer core is in communication with the air inlet chamber. The aerosol generated by atomizing the matrix liquid flows along the airflow toward the nozzle for inhalation by the user. A liquid retaining structure is disposed on the first sealing member at a position corresponding to the liquid inlet of the atomizer core. The liquid retaining structure partially blocks the liquid inlet laterally. When the matrix liquid in the liquid storage chamber flows through the liquid inlet into the atomizer core, the liquid retaining structure modifies the flow rate and/or pressure of the matrix liquid in front of the liquid inlet, so as to match the flow of the matrix liquid with the heating and atomization process of the atomizer core. This prevents excessive flow rate and/or pressure from causing some matrix liquid to leak from the atomizer core toward the nozzle without being atomized.

The following describes some embodiments of the atomizer and atomization device provided by the present application, with reference to the accompanying drawings.

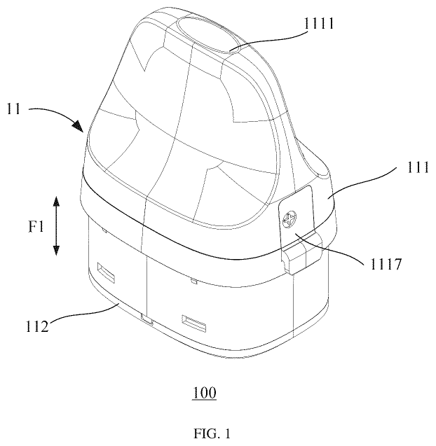

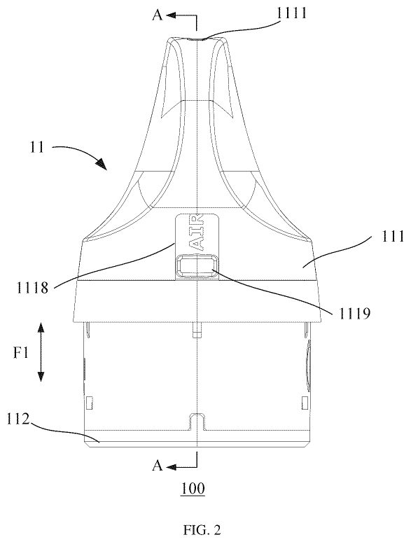

In an embodiment of the first aspect of the present application, as shown in FIGS. 1, 2 and 3, the atomizer 100 includes a housing 11, a first sealing member 12 and an atomizer core 13. An end of the housing 11 in the first direction is provided with a nozzle 1111, the nozzle 1111 is in communication with the external environment, and an exhaust duct 1112 in communication with the nozzle 1111 is provided inside the housing 11; the housing 11 is provided therein with an interior space, the first sealing member 12 is located inside the housing 11 and dividing the interior space into a liquid storage chamber 1113 and an air inlet chamber, the liquid storage chamber 1113 is used to store matrix liquid, and the air inlet chamber is used to allow air to flow in; the first sealing member 12 is provided with a first mounting hole 121 penetrating through the first sealing member 12 in the first direction, and the atomizer core 13 is disposed in the liquid storage chamber 1113 along the first direction, one end of the atomizer core 13 is in communication with the exhaust duct 1112, and another end of the atomizer core 13 extends into the first mounting hole 121 of the first sealing member 12, and the atomizer core 13 is sealingy connected to the first mounting hole 121, so as to isolate the liquid storage chamber 1113 from the air inlet chamber, so as to prevent the matrix liquid in the liquid storage chamber 1113 from leaking into the air inlet chamber. A side wall of the atomizer core 13 is provided with at least one liquid inlet 1311, and the matrix liquid in the liquid storage chamber 1113 can flow into the atomizer core 13 through the liquid inlet 1311 to be heated and atomized; the end of the first sealing member 12 facing the nozzle 1111 is provided with a liquid retaining structure 122, that is, the liquid retaining structure 122 is located in the liquid storage chamber 1113, and at least one liquid inlet 1311 is correspondingly arranged with the liquid retaining structure 122, and on the side of the atomizer core 13, the corresponding liquid inlet 1311 is partially blocked by the liquid retaining structure 122, so that the liquid retaining structure 122 blocks part of the liquid from entering the liquid inlet 131. The matrix liquid flowing into the atomizer core 13 from the front changes the flow rate and/or pressure at the front of the liquid inlet 1311, so that the flow rate and/or pressure of the matrix liquid flowing into the liquid inlet 1311 are compatible with the heating process of the atomizer core 13, so as to fully heat and atomize the matrix liquid flowing into the atomizer core 13. This prevents some the matrix liquid without completely atomized from leaking out of the atomizer core 13 and out of the nozzle 1111 due to excessive flow rate and/or pressure at the liquid inlet 1311, thereby preventing the matrix liquid from leaking out of the atomizer core 13 and affecting the user experience, which also reduces the waste of the matrix liquid.

It is understandable that in existing atomizers, in order to improve the atomization efficiency, the opening of the liquid inlet on the atomizer core is relatively larger, so that the matrix liquid can fully contact the heating area inside the atomizer core. However, since the matrix liquid in the liquid storage chamber has a certain pressure, when the pressure in front of the liquid inlet is too large, the flow rate of the matrix liquid will be further accelerated. Once the flow rate exceeds the atomization capacity of the atomizer core, part of the matrix liquid will not be atomized in time and will leak from the inside of the atomizer core to the nozzle under the action of pressure, and then leak outward, and the normal inhalation of the user is affected.

The embodiment improves and optimizes the internal structure of the atomizer. By providing the liquid retaining structure 122 on the first sealing member 12 connected to the atomizer core 13, the liquid inlet 1311 of the atomizer core 13 is partially blocked laterally by the liquid retaining structure 122. This reduces the liquid flow rate and pressure in front of the atomizer core 13 at the liquid inlet 1311, thereby reducing the likelihood of matrix liquid at the liquid inlet 1311 leaking through the atomizer core 13 without being atomized. This improves the problem of matrix liquid leaking through the nozzle 1111, the user experience is enhanced, the atomization efficiency is improved, and the waste of the matrix liquid is reduced.

It should be noted that in the embodiment, the shape and dimensions of the liquid retaining structure 122 can be appropriately configured based on the shape and dimensions of the liquid inlet 1311, the power of the atomizer core 13, the properties and storage capacity of the matrix liquid, etc., so that the flow rate and pressure in front of the liquid inlet 1311 are compatible with the atomization process of the atomizer core 13. The first sealing member 12 can be made of a flexible member to facilitate sealing.

Furthermore, the number of the liquid inlet 1311 and the liquid retaining structure 122 can be one or more, and the number of which can be arranged according to specific assembly requirements and usage needs.

In a further embodiment of the present application, as shown in FIGS. 3 and 4, a first spacing L is presented between the liquid retaining structure 122 and the outer wall of the atomizer core 13 in the lateral direction of the atomizer core 13. That is, the liquid retaining structure 122 does not contact the outer wall of the atomizer core 13. A liquid inlet channel is formed between the liquid retaining structure 122 and the corresponding liquid inlet 1311. The matrix liquid can flow directly into the atomizer core 13 through the area of the liquid inlet 1311 not blocked by the liquid retaining structure 122, or bypass the liquid retaining structure 122 and flow into the atomizer core 13 through the liquid inlet channel. This ensures that the flow rate of the matrix liquid flowing into the atomizer core 13 through the liquid inlet 1311 remains substantially consistent, thereby preventing interference with the normal atomization operation of the atomizer core 13. In the area of the liquid inlet 1311 blocked by the liquid retaining structure 122, the matrix liquid needs to change direction to bypass the liquid retaining structure 122, so as to reduce frontal impact and pressure, which allows the matrix liquid to flow more smoothly into the atomizer core 13.

Furthermore, as shown in FIGS. 3 to 5, the liquid inlet 1311 includes a blocked area 1312 and an exposed area 1313. The blocked area 1312 is the area directly opposite and blocked by the liquid retaining structure 122, while the area not blocked by the liquid retaining structure 122 is the exposed area 1313.

In one specific implementation, in the first direction, the size of the liquid inlet 1311 is larger than that of the liquid retaining structure 122, and the exposed area 1313 is located at the end of the blocked area 1312 adjacent to the nozzle 1111. That is, the blocked area 1312 is further away from the nozzle 1111 than the exposed area 1313. It will be understood that, typically, the first direction is the height direction of the atomizer 100. Due to the influence of gravity, the pressure of the matrix liquid in the liquid storage chamber 1113 increases the closer to the bottom. Specifically, the pressure of the matrix liquid in the blocked area 1312 is greater than the pressure in the exposed area 1313. The liquid retaining structure 122 blocks the portion of the liquid inlet 1311 away from the nozzle 1111 to reduce the liquid pressure in that portion and to allow the matrix liquid to flow more smoothly into the atomizer core 13.

In another specific implementation, as shown in the examples of FIGS. 4 and 5, in the circumferential direction of the atomizer core 13, the size of the liquid inlet 1311 is smaller than that of the liquid retaining structure 122, such that areas at the same height within the liquid inlet 1311 are equally blocked, that is, both areas at the same height are blocked or exposed. This prevents localized pressure imbalances within the liquid inlet 1311 at the same height, which could accelerate matrix liquid leakage.

Furthermore, as shown in the examples of FIGS. 4 and 5, the blocked area 1312 of the liquid inlet 1311 accounts for ⅔ to ¾ of the total area of the liquid inlet 1311. This effectively mitigates impact and pressure on the front of the liquid inlet 1311, while minimizing the impact of the liquid retaining joint on the flow rate of the liquid inlet 1311. This, combined with the liquid inlet channel between the liquid retaining structure 122 and the atomizer core 13, ensures that the flow rate of the liquid inlet 1311 is substantially the same as that without the liquid retaining structure 122, so as to meet normal atomization operation and user inhalation needs.

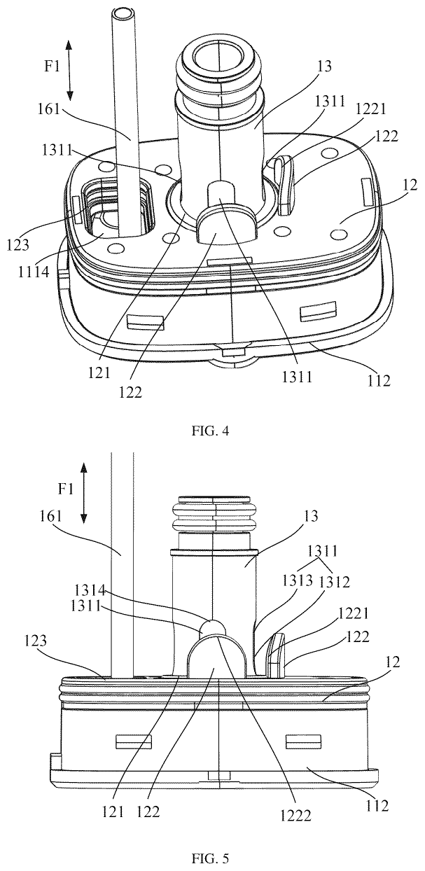

In further embodiments of the present application, as shown in FIGS. 4 to 6, the atomizer core 13 utilizes a cylindrical structure. Accordingly, the side of the liquid retaining structure 122 facing the atomizer core 13 has a curved surface structure 1221 that mates with the atomizer core 13, and the curved surface structure 1221 is coaxially arranged with the atomizer core 13. That is, when viewed from the first direction, the circle where the curved surface structure 1221 is located is concentric with the cylindrical atomizer core 13. At this point, the distance between any position on the curved surface structure 1221 and the corresponding position of the liquid inlet 1311 of the atomizer core 13 is equal, which prevents excessive local flow rate or pressure changes caused by variations in the distance. The curved surface structure 1221 can also be used to direct the matrix liquid, which is conducive to alleviating the flow shock and turbulence. This allows the matrix liquid that bypasses the liquid retaining structure 122 and flows through the liquid inlet channel into the liquid inlet 1311 to flow more smoothly, and prevents the matrix liquid from leaking.

In a further embodiment of the present application, as shown in FIGS. 4 and 5, in the first direction, the end of the liquid inlet 1311 adjacent to the nozzle 1111 is provided with a first curved edge 1314, and accordingly, the end of the liquid retaining structure 122 adjacent to the nozzle 1111 is provided with a second curved edge 1222; the center of the first curved edge 1314 and the center of the second curved edge 1222 are on the same side, that is, the first curved edge 1314 and the second curved edge 1222 are recessed in a same direction. For example, in the example in FIG. 5, in the first direction, the first curved edge 1314 and the second curved edge 1222 are both recessed in a direction adjacent to the nozzle 1111, and the centers are both located on the side away from the nozzle 1111, so that the shape of the exposed area 1313 of the liquid inlet 1311 is relatively smooth, which is conducive to maintaining a smooth flow of the matrix liquid when it flows into the liquid inlet 1311. In the embodiment, the radius of the second curved edge 1222 is greater than or equal to the radius of the first curved edge 1314, so that the outline of the boundary line between the exposed area 1313 and the blocked area 1312 of the liquid inlet 1311 is relatively smooth. It can be understood that when the radius of the second curved edge 1222 is smaller than the radius of the first curved edge 1314, an area that cannot be blocked will appear on one or both sides of the liquid inlet 1311 in the circumferential direction, and the area is in a long strip state or a spike shape, which can easily cause an abnormal increase in local pressure and an acceleration of the liquid flow rate, thereby causing part of the matrix liquid in the corresponding area to leak from the inside of the atomizer core 13 to the nozzle 1111 without being atomized. The above-mentioned problems can be effectively alleviated and the anti-leakage effect is better through the arrangement in this embodiment.

The first curved edge 1314 and the second curved edge 1222 can both be configured as semicircular, major, or minor arcs.

During use of the atomizer 100, when the atomized liquid level in the liquid storage chamber 1113 is low, it can be difficult to replenish the atomizer core 13 with atomized liquid in a timely manner, resulting in the atomizer core 13 momentarily lacking the required amount for atomization and less likely to burn out. In this case, a common solution is to manually shake the atomizer 100 to direct the atomized liquid onto the atomizer core 13, thereby using up the remaining atomized liquid. However, in actual use, when manually shaking the atomizer 100, the remaining atomized liquid on the first sealing member 12 easily flows over both sides of the atomizer core 13, which makes it difficult to smoothly direct the atomized liquid onto the atomizer core 13, thus affecting the user experience.

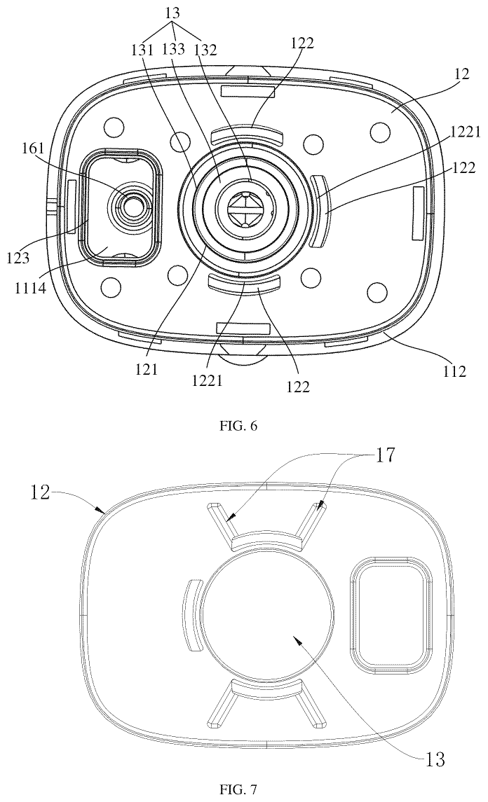

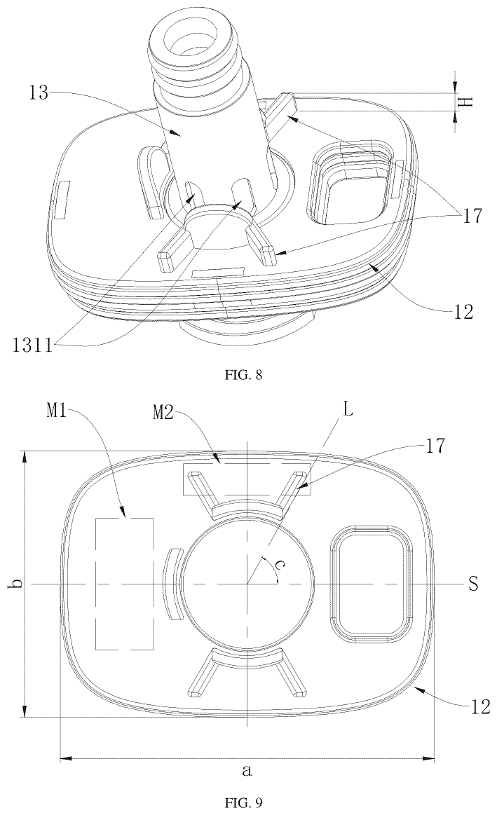

In a further embodiment of the present application, as shown in FIGS. 7 and 8, the first sealing member 12 is provided with raised liquid guide plates 17. These liquid guide plates 17 extend toward the liquid inlet 1311 on the atomizer core 13 and are used to direct atomized liquid toward the liquid inlet 1311 of the atomizer core 13.

In this way, when the atomizer 100 is manually shaken, the liquid guide plates 17 can be used to direct atomized liquid remaining on the first sealing member 12 of the liquid storage chamber 1113 toward the liquid inlet 1311 of the atomizer core 13. This effectively improves the utilization rate of the atomized liquid, prevents the atomizer core 13 from burning out, and thus extends the service life of the atomizer core 13.

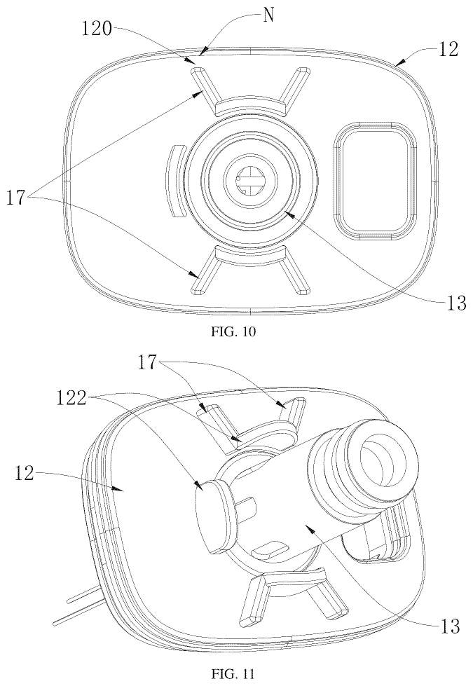

As shown in FIGS. 9 and 10, four liquid guide plates 17 are provided on the first sealing member 12 of the liquid storage chamber 1113. These four liquid guide plates 17 surround the periphery of the atomizer core 13 and are radially distributed on the first sealing member 12.

In actual use, as shown in FIG. 9, at low liquid levels, the atomized liquid primarily resides in the area M1 between the center of the first sealing member 12 and its short side b. When the atomizer 100 is manually shaken, the atomized liquid primarily flows through the narrow area M2 between the center of the first sealing member 12 and its long side a, the atomized liquid cannot flow toward the atomizer core 13 located at the center of the first sealing member 12.

To address this issue, the placement of the liquid guide plates 17 has been modified to address the actual flow path of the atomized liquid. In a further embodiment of the present application, as shown in FIGS. 9 and 10, every two of the four liquid guide plates 17 form a group. The two groups of liquid guide plates 17 are respectively positioned on opposite sides of the atomizer core 13, and are respectively extended toward the long sides a of the first sealing member 12.

Thus, the liquid guide plates 17 are positioned in the narrow area M2 between the center of the first sealing member 12 and the long side a of the first sealing member 12, so as to block the atomized liquid flowing through this area and directing the atomized liquid toward the atomizer core 13 located at the center of the first sealing member 12, thereby improving the directing effect of the atomized liquid.

Preferably, as shown in FIG. 9, the extension line L of the liquid guide plate 17 toward the center of the first sealing member 12 intersects the middle line S between the two long sides a to form an inclination angle c of the liquid guide plate 17. The inclination angle c of the liquid guide plate 17 is preferably ranged from 45° to 90°.

A smaller inclination angle c is more conducive to increasing the directed flow rate, while a larger inclination angle c is more conducive to reducing the amount of liquid stored. “The amount of liquid stored” here can be understood as the amount of atomized liquid trapped by the liquid guide plate 17 in front of the liquid guide plate 17. After numerous tests and experiments, the inventors have determined that the inclination angle of the liquid guide plate 17 being set to be ranged from 50° to 70°, or preferably 60°, ensures the flow rate of the liquid while reducing the amount of liquid trapped in front of the liquid guide plate 17, thereby improving the diversion effect.

In another embodiment of the present application, as shown in FIG. 10, the extension end of the liquid guide plate 17 and the inner wall N of the housing 11 are spaced apart to form a drainage gap 120.

As shown in FIGS. 9 and 10, each liquid guide plate 17 extends toward the long side a of the first sealing member 12, the extension end of the liquid guide plate 17 and the inner wall N located on the long side a of the first sealing member 12 are spaced apart to form a drainage gap 120. This helps reduce the amount of liquid trapped in front of the liquid guide plate 17 by the liquid guide plate 17, allow the atomized liquid to flow through the drainage gap 120 and be redirected to the atomizer core 13.

Regarding the height setting of the liquid guide plate 17, if the height of the liquid guide plate 17 is too high, the liquid guide plate 17 will form a partition in the liquid storage chamber. When the liquid storage chamber is saturated with atomized liquid, this can easily block the flow of liquid and affect the normal liquid supply to the atomizer core 13. If the height of the liquid guide plate 17 is too low, the liquid guide plate 17 will not be able to block or direct the liquid.

The height setting of the liquid guide plate 17 is particularly important. In a further embodiment of the present application, as shown in FIG. 8, the height H of the liquid guide plate 17 raised from the first sealing member 12 is one-third of the diameter of the liquid inlet 1311. As an example, the height H of liquid guide plate 17 can be preferably set to be ranged from 1.5 to 2.0 mm.

In the atomizer 100 of the present application, the liquid inlet 1311 on the atomizer core 13 is located adjacent to the first sealing member 12. This means that when the liquid in the liquid storage chamber is saturated, the liquid level is higher than the liquid inlet 1311 on the atomizer core 13. the height of the liquid guide plate 17 is one-third the diameter of the liquid inlet 1311, which helps avoid blocking of the atomized liquid flowing to the liquid inlet 1311.

The height of the liquid guide plate 17 in the embodiment is set to block low-level atomized liquid and direct the atomized liquid to the liquid inlet 1311 of the atomizer core 13, which effectively reduces the impact on the internal structure of the liquid storage chamber.

For the specific shape of the liquid guide plate 17, as shown in FIGS. 7, 8, and 9 in the embodiments of the present application, the liquid guide plate 17 is a straight plate with a simple structure, which is conductive to improving the diversion rate, avoid the formation of residue collection areas, and reduce the difficulty of production and assembly.

In other embodiments (not shown), the liquid guide plate 17 can also be a curved plate. The curved plate structure allows the atomized liquid, after being trapped by the liquid guide plate 17, to quickly change direction along the curved plate surface and be directed toward the atomizer core 13, which effectively improves the diversion effect.

In another embodiment of the present application, the outer edges and corners of the liquid guide plate 17 are preferably curved, which is conductive to improving the smoothness of the flow of the atomized liquid through the liquid guide plate 17.

Preferably, as shown in FIGS. 9 and 11, both sides of the liquid retaining structure 122 are connected with liquid guide plates 17 that are symmetrically arranged. In the embodiment, in order to match the shape of the first sealing member 12 of the present application, the liquid guide plate 17 is preferably connected to the liquid retaining structure 122 facing away from the long side a of the first sealing member 12, so that the extension end of the liquid guide plate 17 extends toward the long side a of the first sealing member 12, so that the liquid guide plate 17 is arranged for the movement path of the atomized liquid during a low liquid level. During the directing operation, the user can utilize the gaps between the liquid retaining structures 122 to quickly direct the atomized liquid to the atomizer core 13, so as to prevent the atomizer core 13 from burning out.

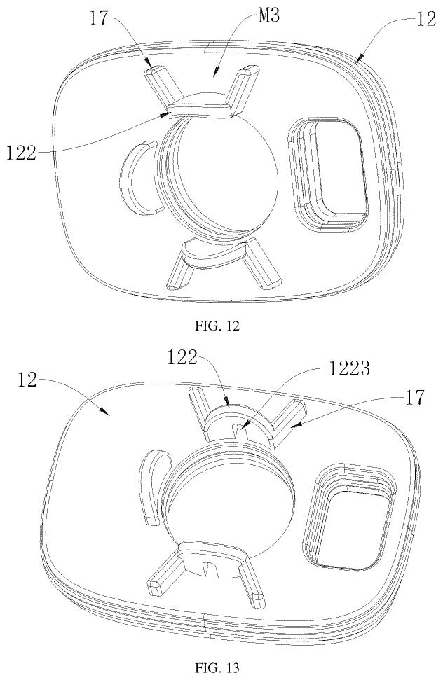

Based on the above description, as shown in FIG. 12, the liquid retaining structure 122 and the liquid guide plates 17 connected to two sides of the liquid retaining structure 122 form a U-shaped liquid collection groove M3. The atomized liquid remaining in the liquid collection groove M3 is difficult to flow out and cannot be redirected to the atomizer core 13, thus affecting the utilization rate of the atomized liquid in the liquid storage chamber 1113.

To address this issue, in another embodiment of the present application, as shown in FIG. 13, the liquid retaining structure 122 provided with liquid guide plates 17 at two sides of which is provided with drainage holes 1223, such that the atomized liquid remaining in the liquid collection groove M3 is allowed to be discharged through the drainage holes 1223 on the liquid retaining structure 122, and flows directly to the atomizer core 13 or being redirected to the atomizer core 13. This effectively solves the problem of liquid easily accumulating between the liquid retaining structure 122 and the liquid guide plates 17 on two sides of the liquid retaining structure 122.

Preferably, the liquid guide plate 17 is integrally connected to the liquid retaining structure 122 and the first sealing member 12 to enhance sealing and improve diversion efficiency. This facilitates integrated manufacturing, reducing production complexity and costs.

In a further embodiment of the present application, as shown in FIGS. 3 and 4, the atomizer core 13 includes an atomizer core sleeve 131, an atomizer core body 132, and a liquid obsorption structure 133. The atomizer core sleeve 131 extends in the first direction, with one end connected to the exhaust duct 1112 and another end sealingly connected to the first mounting hole 121, so as to allow communication between the nozzle 1111 and the air inlet chamber via the atomizer core sleeve 131 and the exhaust duct 1112. The atomizer core body 132 and the liquid obsorption structure 133 are disposed within the atomizer core sleeve 131, and the atomizer core body 132 is provided with an air passage extending along the first direction. The liquid obsorption structure 133 covers the outer surface of the atomizer core body 132. A liquid inlet 1311 is provided on the side wall of the atomizer core sleeve 131, and is located corresponding to a position of the atomizer core body 132. The matrix liquid in the liquid storage chamber 1113 entering the atomizer core sleeve 131 through the liquid inlet 1311 is adsorbed onto the liquid obsorption structure 133, and then permeates through the liquid obsorption structure 133 to different areas on the outer surface of the atomizer core body 132, so as to ensure more uniform heating of the atomizer core body 132 and improve the atomization efficiency. The heated matrix liquid is atomized to produce an aerosol, which is carried by the airflow in the air passage toward the nozzle 1111 for inhalation by the user.

As shown in the example of FIG. 3, the end of the atomizer core sleeve 131 away from the nozzle 1111 is extended into the first mounting hole 121 of the first sealing member 12. The inner wall of the first mounting hole 121 is provided with a plurality of raised structures for sealing. These raised structures press against the outer wall of the portion of the atomizer core sleeve 131 extending into the first mounting hole 121 to form an interference fit and thereby achieving a sealed connection. Furthermore, the atomizer core body 132 includes a conductive portion 1321 (e.g., a pin structure) extending outside the atomizer core sleeve 131 to connect to an electrode. During use, the conductive portion 1321 can be electrically connected to a power supply via the electrode, thereby supplying power to the atomizer core body 132.

In further embodiments of the present application, as shown in FIGS. 3, 14, and 15, the housing 11 includes an air inlet duct 1115, one end of the air inlet duct 1115 is in communication with the air inlet chamber and another end is in communication with the atmosphere. The atomizer 100 also includes a support seat 14. The support seat 14 is disposed in the air inlet chamber of the housing 11. An air guiding chamber 141 is formed in the support seat 14, and a first communication port 142 and a second communication port 143 are formed on the support seat 14. The two ends of the first communication port 142 are respectively in communication with the air guiding chamber 141 and the end of the atomizer core 13 away from the nozzle 1111, and the two ends of the second communication port 143 are respectively in communication with the air guiding chamber 141 and the air inlet chamber, so as to realize the communication between the air inlet duct 1115 and the atomizer core 13 through the air inlet chamber and the air guiding chamber 141 in the support seat 14. After being guided by the air guiding chamber 141, the intake air flow enters the interior of the atomizer core 13 from the end of the atomizer core 13 away from the nozzle 1111, and then carries the aerosol generated in the atomizer core 13 to flow toward the nozzle 1111. Furthermore, the support seat 14 is located at the end of the atomizer core 13 facing away from the nozzle 1111 in the first direction. That is, during use, the support seat 14 is positioned below the atomizer core 13. The support seat 14 provides support for the atomizer core 13, so as to facilitate fixing the atomizer core 13.

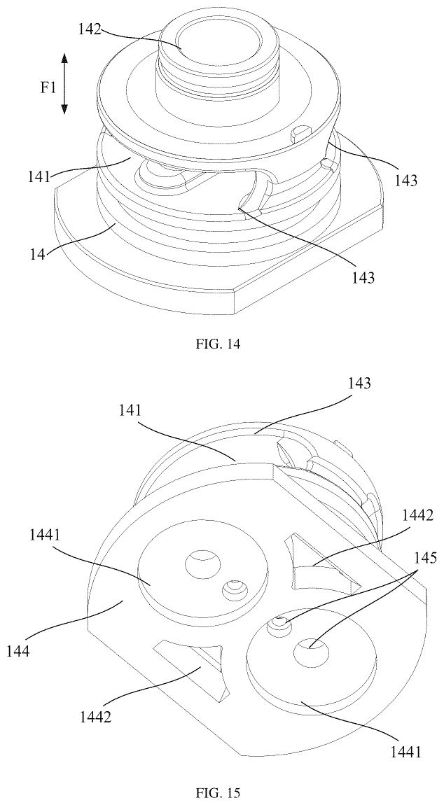

The first communication port 142 of the support seat 14 is connected to the first mounting hole 121 of the first sealing member 12 to connect with the atomizer core 13. Specifically, as shown in the example of FIG. 3, a cylindrical structure can be provided at the end of the support seat 14 facing the nozzle 1111. The first communication port 142 is located at the end of the cylindrical structure, the cylindrical structure extends into the first mounting hole 121 of the first sealing member 12 to form a nested connection with the atomizer core 13. One or more second communication ports 143 can be provided. Specifically, as shown in the example of FIG. 14, one second communication port 143 can be provided on each of the opposing side walls of the support seat 14. In order to further increase the flow area, the second communication ports 143 can be designed as an open, hollow structure.

In another specific implementation, the air inlet duct 1115 can also be directly connected to the second communication port 143 of the support seat 14, which can achieve the same air intake effect. The specific design can be selected according to actual assembly requirements.

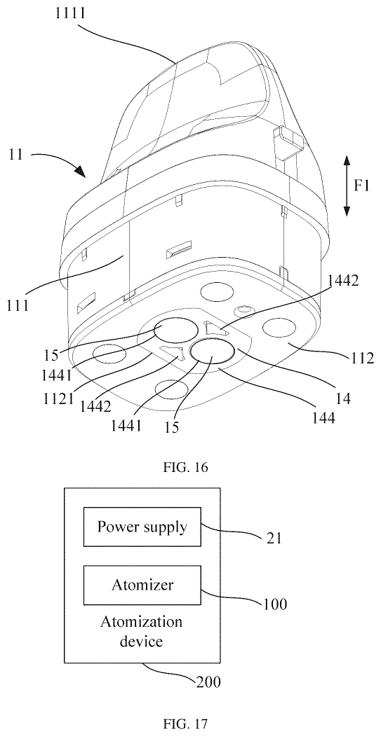

Furthermore, as shown in FIGS. 3, 15, and 16, the end of the housing 11 away from the nozzle 1111 is provided with a second mounting hole 1121 penetrating through the housing 11 in the first direction. The end of the support seat 14 away from the nozzle 1111 is mounted in the second mounting hole 1121 of the housing 11. The end of the support seat 14 away from the nozzle 1111 forms an assembly end 144, the assembly end 144 is exposed through the second mounting hole 1121. The assembly end 144 is provided with an electrode mounting groove 1441 and a process assembly groove 1442. A through hole 145 is formed within the support seat 14 communicating the air guiding chamber 141 with the electrode mounting groove 1441. The electrode 15 is mounted in the electrode mounting groove 1441. The conductive portion 1321 of the atomizer core 13 passes through the first communication port 142 and the air guiding chamber 141, extending through the through hole 145 into the electrode mounting groove 1441, thereby forming an electrical connection with the electrode 15. During use, the electrode 15 can be electrically connected to an external power supply, which can then supply power to the atomizer core 13 to achieve heating operation.

The process assembly groove 1442 is used for connection and assembly with external processing device. During assembly of the atomizer 100, the assembly end 144 of the support seat 14 can be connected to an external processing device and positioned therewith via the process assembly groove 1442. When the conductive portion 1321 of the atomizer core 13 extends from the through hole 145 into the electrode mounting groove 1441, the conductive portion 1321 contacts the corresponding structure on the external processing device and bends under pressure to facilitate electrical connection with the electrode 15. The process assembly groove 1442 enables to match with the external processing device, so as to achieve the automatic bending, which improves the assembly efficiency and the operational accuracy.

It should be noted that the number of electrode mounting grooves 1441 can be two, as shown in FIG. 15, so as to arrange two electrodes 15, one corresponding to the positive and one corresponding to the negative pole of the power supply. Specifically, the electrodes 15 can be configured as electrode sheets, which reduces space usage and increases contact area. Furthermore, the number of process assembly grooves 1442 can be two, as shown in FIG. 15, or any other number can be provided depending on the structure of the external processing device.

In an embodiment of the second aspect of the present application, an atomization device 200 is provided. As shown in FIGS. 1, 16, and 17, the atomization device 200 includes a power supply 21 and the atomizer 100 described in any of the embodiments of the first aspect. The atomizer core 13 of the atomizer 100 is electrically connected to the power supply 21. The power supply 21 supplies power to the atomizer core 13, causing the atomizer core 13 to heat, thereby atomizing the matrix liquid and generating an aerosol. The aerosol flows along with the airflow toward the nozzle 1111 of the atomizer 100 for inhalation by the user.

Furthermore, the power supply 21 includes a detachable connection structure (e.g., a snap-fit structure) to connect and assemble with the atomizer 100, to form an integrated structure for easy user operation.

In actual applications, the power supply 21 can also be separate from the atomizer 100, electrically connected to the atomizer core 13 only via a cable or other means, to similarly supply power to the atomizer core 13.

Furthermore, the atomization device 200 of the embodiment also possesses all the beneficial effects of the atomizer 100 of any of the aforementioned embodiments, which will not be further elaborated here.

The following describes a specific embodiment of the atomizer 100 of the present application with reference to the accompanying drawings.

As shown in FIGS. 1 to 16, the atomizer 100 includes a housing 11, a first sealing member 12, and an atomizer core 13. The housing 11 specifically includes a shell 111 and a base 112 detachably connected to the shell 111. The height direction of the housing 11 is the first direction. In the first direction, an end of the shell 111 is provided with a nozzle 1111, and the another end of the shell 111 is an opened structure. The base 112 is connected to the end of the shell 111 away from the nozzle 1111 and is detachably connected to the shell 111 via a snap-fit structure. The portion of the shell 111 adjacent to the nozzle 1111 can be a double-layered structure to facilitate molding, processing, and assembly of the nozzle 1111.

The first sealing member 12 is made of flexible silicone and is positioned within the housing 11 adjacent to the base 112, the periphery of the first sealing member 12 is sealingly abutted against the inner wall of the housing 11, and divide the interior space of the housing 11 into a liquid storage chamber 1113 and an air inlet chamber in the first direction. The liquid storage chamber 1113 is located adjacent to the nozzle 1111, while the air inlet chamber is located adjacent to the base 112. A first mounting hole 121 is disposed on a position of the first sealing member 12 opposite to the nozzle 1111. This first mounting hole 121 is penetrated through in the first direction. One end of the atomizer core 13 extends into the first mounting hole 121 and forms a sealed connection with the first sealing member 12 via a raised structure on the inner wall of the first mounting hole 121. An integrated exhaust duct 1112 is provided within the shell 111. One end of the exhaust duct 1112 is in communication with the nozzle 1111, and another end of the exhaust duct 1112 is in communication with the atomizer core 13.

A support seat 14 is provided within the air inlet chamber, and an air guiding chamber 141 is formed within the support seat 14. The end of the support seat 14 facing the nozzle 1111 has a first cylindrical communication port 142 extending into the first mounting hole 121 and connected to the atomizer core 13; the side wall of the support seat 14 is provided with a second communication port 143 in a hollowed-out form to communicate the air guiding chamber 141 with the air inlet chamber. The first sealing member 12 also has an air inlet opening 123 penetrating through in the first direction, an independent air inlet duct 1115 is formed inside the shell 111. One end of the air inlet duct 1115 is in communication with the air inlet port 1118 on the shell 111, and another end of the air inlet duct 1115 is sealingy connected to the air inlet opening 123, such that the air inlet duct 1115 is in communication with the air inlet chamber. In the embodiment, an air inlet valve 1119 is provided at the air inlet 1118 of the shell 111, and the air inlet 1118 can be opened or closed by sliding the air inlet valve 1119, so that the air inlet 1118 can be closed when the atomizer 100 is not in use to achieve dust prevention, and at the same time, it can also prevent external airflow from entering and affecting the atomizer core 13 and the matrix liquid.

As shown in FIG. 3, the shell 111 also includes an independent sensing airway 161, the sensing airway 161 runs through the air inlet duct 1115. One end of the sensing airway 161 passes through the air inlet opening 123 and extends to the end of the base 112 away from the nozzle 1111 to be in communication with the external environment. Another end of the sensing airway 161 extends to the nozzle 1111 of the shell 111 and is in communication with the nozzle 1111. An airflow sensor 162 is located adjacent to the nozzle 1111 in the sensing airway 161, and the airflow sensor 162 is electrically connected to the power supply or the atomizer core 13, such that when a user inhales through the nozzle 1111, negative pressure generates airflow within the sensing airway 161. When the airflow sensor 162 senses the airflow and triggers a corresponding sensing signal, the power supply energizes the atomizer core 13 to perform the heating and atomizing operation.

The liquid storage chamber 1113 stores the matrix liquid, and the atomizer core 13 is located within the liquid storage chamber 1113. The atomizer core 13 is specifically a cylindrical structure, including an atomizer core sleeve 131, an atomizer core body 132 located in the atomizer core sleeve 131, and a liquid obsorption structure 133. A plurality of liquid inlets 1311 are provided on the outer wall of the atomizer core sleeve 131, specifically four liquid inlets 1311 arranged at equal intervals along the circumferential direction, one of the liquid inlets 1311 is arranged opposite to the air inlet duct 1115, and liquid retaining structures 122 are provided at positions of the end of the first sealing member 12 facing the nozzle 111 corresponding to the other three liquid inlets 1311. On the lateral side of the atomizer core sleeve 131, a first spacing L is formed between each liquid retaining structure 122 and the corresponding liquid inlet 1311, and each liquid retaining structure 122 blocks the portion of the corresponding liquid inlet 1311 adjacent to the first sealing member 12, so that the liquid inlet 1311 is divided into a blocked area 1312 and an exposed area 1313. The area of the blocked area 1312 accounts for ⅔ to ¾ of the total area of the liquid inlet 1311. The side of the liquid retaining structure 122 facing the atomizer core 13 is provided with a curved surface structure 1221, the curved surface structure 1221 is coaxial with the atomizer core 13. The end of the liquid inlet 1311 adjacent to the nozzle 1111 is provided with a first curved edge 1314. Correspondingly, the end of the liquid retaining structure 122 facing the nozzle 1111 is provided with a second curved edge 1222, the radius of the second curved edge 1222 is greater than or equal to the radius of the first curved edge 1314. The liquid retaining structure 122 can reduce the liquid flow rate and pressure of the atomizer core 13 in front of the liquid inlet 1311, thereby reducing the possibility of the matrix liquid at the liquid inlet 1311 leaking through the atomizer core 13 without being atomized, so as to improve the problem of matrix liquid leaking through the nozzle 1111, which is beneficial to improving the user experience, while also improving the atomization efficiency and reducing the waste of matrix liquid.

A liquid filling port 1116 is provided on the side of the shell 111 opposite to the air inlet 1118 for supplying and withdrawing the matrix liquid from the liquid storage chamber 1113. A liquid filling plug 1117 is provided at the liquid filling port 1116 to close the liquid filling port 1116. The liquid filling plug 1117 can be removed to open the liquid filling port 1116 during use.

The base 112 is provided with a first mounting hole 121 and a second mounting hole 1121 opposite the first mounting hole 121. The second mounting hole 1121 penetrates through the base 112 in a first direction. The support seat 14 is mounted in the second mounting hole 1121 of the base 112 and is sealingly connected with the second mounting hole 1121. The end of the support seat 14 away from the nozzle 1111 is an assembly end 144, and the assembly end 144 is exposed through the second mounting hole 1121. The assembly end 144 is provided with two electrode mounting grooves 1441 and two process assembly grooves 1442. Each electrode mounting groove 1441 is mounted with an electrode sheet. Two conductive portions 1321 of the atomizer core 13 respectively extend through the first communication port 142, the air guiding chamber 141, and the through hole 145 in the support seat 14 into their corresponding first electrode mounting grooves 1441. The conductive portions are bent and electrically connected to the corresponding electrode sheets. The process assembly grooves 1442 are used to connect to external processing device during assembly, so as to perform the automatic bending of the conductive portions 1321 to improve assembly efficiency.

During use, the atomizer 100 can be assembled and connected to a power supply, such that the electrode sheets of the atomizer 100 are electrically connected to the power supply to supply power to the atomizer core 13. When a user inhales through the nozzle 1111, the airflow sensor 162 senses the airflow and generates a corresponding sensing signal, energizing the power supply, causing the atomizer core body 132 to heat, atomizing the matrix liquid flowing into the atomizer core and generating an aerosol. The airflow entering the atomizer core through the air inlet duct 1115 carries the aerosol toward the nozzle 1111 for inhalation by the user.

The aforementioned embodiments are only preferred embodiments of the present application, and should not be regarded as being limitation to the present application. Any modification, equivalent replacement, improvement, and so on, which are made within the spirit and the principle of the present application, should be included in the protection scope of the present application.

What is claimed is:

1. An atomizer, comprising:
a housing, provided with a nozzle at one end of the housing in a first direction, wherein an exhaust duct in communication with the nozzle is provided within the housing;
a first sealing member, disposed within the housing and divided an interior space of the housing into a liquid storage chamber and an air inlet chamber, wherein the first sealing member is provided with a first mounting hole, and an end of the first sealing member facing the nozzle is provided with a liquid retaining structure; and
an atomizer core, disposed within the liquid storage chamber, an end of the atomizer core being in communication with the exhaust duct, and another end of the atomizer core extending into the first mounting hole and being sealingly connected with the first mounting hole; wherein a side wall of the atomizer core is provided with at least one liquid inlet, and at least one of liquid inlets is disposed corresponding to the liquid retaining structure in a lateral direction of the atomizer core, and is partially blocked by the liquid retaining structure.

2. The atomizer according to claim 1, wherein a first spacing is presented between the liquid retaining structure and an outer wall of the atomizer core, such that a liquid inlet channel is formed between the liquid retaining structure and the corresponding liquid inlet.

3. The atomizer according to claim 2, wherein a size of the liquid inlet is larger than a size of the liquid retaining structure in the first direction, wherein the liquid inlet comprises a blocked area and an exposed area, the exposed area is located at an end of the blocked area adjacent to the nozzle; and/or
a size of the liquid inlet is smaller than a size of the liquid retaining structure in a circumferential direction of the atomizer.

4. The atomizer according to claim 3, wherein an area of the blocked area accounts for ⅔ to ¾ of a total area of the liquid inlet.

5. The atomizer according to claim 2, wherein the atomizer core is a cylindrical structure; a side of the liquid retaining structure facing the atomizer core is provided with a curved surface structure, and the curved surface structure is arranged coaxially with the atomizer core.

6. The atomizer according to claim 2, wherein an end of the liquid inlet adjacent to the nozzle is provided with a first curved edge; and
an end of the liquid retaining structure adjacent to the nozzle is provided with a second curved edge, a center of the first curved edge and a center of the second curved edge are located on a same side, and a radius of the second curved edge is greater than or equal to a radius of the first curved edge.

7. The atomizer according to claim 1, wherein the first sealing member is further provided with a raised liquid guide plate, and the liquid guide plate is configured to direct an atomized liquid toward the liquid inlet of the atomizer core.

8. The atomizer according to claim 7, wherein the first sealing member is provided with a plurality of liquid guide plates, and the plurality of liquid guide plates are arranged radially outwardly around a periphery of the atomizer core.

9. The atomizer according to claim 7, wherein the first sealing member is provided with two long sides opposite to each other and two short sides opposite to each other; an extension line from the liquid guide plate toward a center of the first sealing member intersects a middle line between the two long sides of the first sealing member to form an inclination angle of the liquid guide plate, and the inclination angle of the liquid guide plate is ranged from 45° to 90°.

10. The atomizer according to claim 7, wherein a drainage gap is formed between an extension end of the liquid guide plate and an inner wall of the housing.

11. The atomizer according to claim 7, wherein a height of the liquid guide plate rising from the first sealing member is one-third of a diameter of the liquid inlet.

12. The atomizer according to claim 7, wherein the liquid guide plates are symmetrically connected to two sides of the liquid retaining structure, and the liquid retaining structure with two sides being connected with the liquid guide plates are provided with drainage holes.

13. The atomizer according to claim 7, wherein the liquid guide plate is integrally connected to the liquid retaining structure and the first sealing member.

14. The atomizer according to claim 1, wherein the atomizer core comprises:
an atomizer core sleeve, an end of the atomizer core sleeve is connected to the exhaust duct and another end of the atomizer core sleeve is sealingly connected to the first mounting hole, and the liquid inlet is deposed on a side wall of the atomizer core sleeve;
an atomizer core body, disposed within the atomizer core sleeve and is provided with an air passage channel penetrating through the atomizer core body in the first direction; and
a liquid obsorption structure, disposed within the atomizer core sleeve and covers an outer surface of the atomizer core body.

15. The atomizer according to claim 1, wherein the atomizer further comprises a support seat disposed within the air inlet chamber, an air guiding chamber is formed within the support seat, and the support seat is provided with a first communication port and a second communication port that are in communication with the air guiding chamber;
the housing is provided with an air inlet duct communicating the air inlet chamber with an external atmosphere; and
the first communication port is in communication with an end of the atomizer core away from the nozzle, and the second communication port is in communication with the air inlet chamber or the air inlet duct.

16. The atomizer according to claim 15, wherein an end of the housing away from the nozzle is provided with a second mounting hole penetrating through the housing in the first direction;
an end of the support seat away from the nozzle is an assembly end, the assembly end is disposed in the second mounting hole and is provided with an electrode mounting groove and a process assembly groove, the support seat is provided with a through hole configured for communicating the air guiding chamber with the electrode mounting groove, and a conductive portion of the atomizer core extends through the through hole and into the electrode mounting groove;
an electrode is mounted in the electrode mounting groove, the electrode is electrically connected to the conductive portion of the atomizer core and capable of being electrically connected to a power supply; and
the process assembly groove is configured to connect and assemble with an external processing device, so that the conductive portion of the atomizer core is able to be bent by the external processing device during processing.

17. An atomization device, comprising:
a power supply; and
an atomizer, comprising:
a housing, provided with a nozzle at one end of the housing in a first direction, wherein an exhaust duct in communication with the nozzle is provided within the housing;
a first sealing member, disposed within the housing and divided an interior space of the housing into a liquid storage chamber and an air inlet chamber, wherein the first sealing member is provided with a first mounting hole, and an end of the first sealing member facing the nozzle is provided with a liquid retaining structure; and
an atomizer core, disposed within the liquid storage chamber, an end of the atomizer core being in communication with the exhaust duct, and another end of the atomizer core extending into the first mounting hole and being sealingly connected with the first mounting hole; wherein a side wall of the atomizer core is provided with at least one liquid inlet, and at least one of liquid inlets is disposed corresponding to the liquid retaining structure in a lateral direction of the atomizer core, and is partially blocked by the liquid retaining structure
wherein an atomizer core of the atomizer is electrically connected to the power supply.
